(19) United States
(12) Patent Application Publication
(10) Pub. No.: US 2025/0373649 A1
(43) Pub. Date: Dec. 4, 2025

(54) SYSTEM AND METHOD OF VALIDATING A DOMAIN NAME SYSTEM QUERY

(71) Applicant: Radware Ltd., Tel Aviv (IL)

(72) Inventors: Gabi NAKIBLY, Tel Aviv (IL); David AVIV, Tel Aviv (IL); Noam DROR, Yad Mordechai (IL); Moshe ITSHAK, Giv'at Shmuel (IL)

(73) Assignee: Radware Ltd., Tel Aviv (IL)

(21) Appl. No.: 18/676,904

(22) Filed: May 29, 2024

(51) Int. Cl. H04L 9/40

(52) U.S. Cl. CPC H04L 63/1441

(57) ABSTRACT

A system and method for validating a domain name system (DNS) query using a DNS challenge. The method includes sending a response to a first source Internet protocol (IP) address, wherein the response has a modified domain name that includes a first token, the first source IP address, and an original domain name; determining receipt of a return query for the modified domain name, wherein the return query is received from a second source IP address; upon receipt of the return query, determining a second token for the return query by executing a function with respect to the first source IP address in the modified domain name; and validating the return query by comparing the first token and the determined second token, wherein the first token is extracted from the modified domain name of the return query.

### TECHNICAL FIELD

The present disclosure relates generally to implementation of security techniques for detecting domain name system (DNS) attacks.

### BACKGROUND

A significant problem facing the Internet community is that online businesses and organizations are vulnerable to malicious attacks. Cyber-attacks have been executed using a wide arsenal of attack techniques and tools targeting both information maintained by online businesses and their IT infrastructures. Cyber-attacks typically aim to steal data, disable applications or services, or damage online assets of organizations. For example, a domain name system (DNS)-based distributed denial-of-service (DDoS) attack is an example of an attack that can damage the network infrastructure and disable applications, services, and websites.

Another related example is a spoofing based attack where an attacker may disguise as a trusted source to gain access to protected and privileged information. Various portions of the DNS may be spoofed, for example, but not limited to, a DNS query, a DNS resolver, an IP address, and the like, and any combination thereof. The malicious attacker may leverage its disguised identity to gain access to authoritative name servers, other DNS resolvers, or the like, to cause, for example, reconfigurations, DDoS attacks, and the like.

One method of executing DNS-based DDoS attacks is by exploiting recursive DNS resolvers to send a query flood to authoritative DNS servers. Such attacks are collectively referred to as a recursive random subdomain attack. Execution of such an attack is described herein with respect to FIG. 1. A recursive random subdomain attack can also target the recursive resolver itself by consuming CPU resources and denying service from legitimate customers.

A recursive DNS resolver 110 is deployed between a client device 120 and a plurality of authoritative DNS name servers 130-1 through 130-n. The client device 120 sends a recursive query to the DNS resolver 110 including a query name (or domain name). The DNS resolver 110 returns an Internet Protocol (IP) address corresponding to the query name. A query name typically includes one or more labels delimited by periods that are translated from right (“top level domain”) to left (“subdomain”). For example, in a fully qualified domain name (FQDN) of “www.example.com.”, the root level is represented by the ‘.’, top level domain is “.com”, the domain is “example.com”, and the subdomain is “www”.

An authoritative DNS name server 130 answers only the queries for the zone (a domain name space) that it is responsible for, in order to quickly respond to resolver queries. An authoritative name server 130 does not respond to recursive queries and does not cache query results.

To resolve a FQDN, the DNS recursive server (also referred to as a recursive DNS resolver) 110 first checks if an IP address for the domain name is saved in its cache. If so, the IP address is returned in a query response. If the query cannot be resolved based on the cached information, the recursive DNS resolver 110 queries a root DNS server (e.g., the name server 130-1).

If the root name server 130-1 is authoritative for the top-level domain (e.g., “.com”), the server 130-1 refers the resolver to the next authoritative DNS name server for the domain (e.g., “example.com”). The name server (e.g., the name server 130-2) delegated by the root name server 130-1 refers the query to yet another DNS server (e.g., the name server 130-n) that is authoritative for the next subdomain level (e.g., “s1.example.com”). This trail of referrals continues until the FQDN is resolved. Thus, queries are often forwarded to multiple authoritative DNS name servers 130. The recursive resolver continues until the name server in charge of the domain (e.g., “www.s1.example.com”) returns the IP address to the recursive resolver, which forwards it to the original requester.

The full domain name can also be resolved by querying only one authoritative DNS server, as the DNS recursive resolver 110 has knowledge about such a name server. A domain name fully resolved by one of the name servers 130-1 through 130-n is cached at the DNS resolver 110 and returned as a query response to the client device 120.

If the root name server 130-1 is not authoritative for that particular top-level domain name, the root name server 130-1 refers the query to other authoritative DNS name servers 130 that may be able to resolve the query. The DNS name servers 130 hold information such as, but not limited to, A records, NS records, MX records, CNAME records, and the like, and any combination thereof that are accessed by the DNS resolver 110 to fully resolve the domain. To this end, secure and undisrupted operation of the name servers is desired.

DNS queries and responses are transmitted using the user datagram protocol (UDP) and, thus, such transmissions are vulnerable to various forms of malicious activity. A recursive DNS attack targets the recursive DNS resolver 110 to achieve denial of service for legitimate users using the same resolution service. To this end, during a recursive DNS attack, the attacker generates multiple DNS queries using forged and random full or subdomain names. The recursive DNS resolver 110 triggers the resolution process discussed above to resolve these queries, as most likely the responses are not cached. Handling a magnitude of recursive DNS queries overloads the operation of the DNS resolver 110. Furthermore, a crafted recursive random subdomain attack can also flood a specific target domain.

In some cases, an attacker may use a spoofed IP source address to impersonate trusted sources (e.g., a trusted DNS resolver 110) and gain access to the authoritative DNS servers 130. The attacker may generate and send malicious DNS queries to the authoritative DNS servers that cause, for example, but not limited to, DDos-based DNS attacks, reconfiguration, and the like, and more. A typical DDos-based DNS attack includes a high volume of malicious DNS queries that are carried out by botnets capable of issuing millions of DNS queries within a few seconds, thereby quickly bringing the DNS servers to complete denial of service.

In an environment where attacks are executed by botnets, manual intervention (by a security administrator) during an attack in order to accurately distinguish between attack “bad” queries and legitimate “good” queries has no effect. Many existing solutions provide an indication of suspicious DNS activity only when DNS error responses (for example, NXDomain) are generated in high volume. Such detection is often too late for the DNS server, which has already failed due to exhausted resources. Early and accurate detection of a DNS attack based on the incoming queries is a key advantage for efficient DNS DDoS protection. Moreover, early detection of potentially malicious and/or legitimate queries to prevent onset of DNS attacks is yet another preventative and protective measure.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for defending a domain name system (DNS) name server from malicious attacks using a DNS challenge. The method comprises: sending a response to a first source Internet protocol (IP) address, wherein the response has a modified domain name that includes a first token, the first source IP address, and an original domain name; determining receipt of a return query for the modified domain name, wherein the return query is received from a second source IP address; upon receipt of the return query, determining a second token for the return query by executing a function with respect to the first source IP address in the modified domain name; and validating the return query by comparing the first token and the determined second token, wherein the first token is extracted from the modified domain name of the return query.

Certain embodiments disclosed herein also include a non-transitory computer readable medium having stored thereon causing a processing circuitry to execute a process, the process comprising: sending a response to a first source Internet protocol (IP) address, wherein the response has a modified domain name that includes a first token, the first source IP address, and an original domain name; determining receipt of a return query for the modified domain name, wherein the return query is received from a second source IP address; upon receipt of the return query, determining a second token for the return query by executing a function with respect to the first source IP address in the modified domain name; and validating the return query by comparing the first token and the determined second token, wherein the first token is extracted from the modified domain name of the return query.

Certain embodiments disclosed herein also include a system for [to be completed based on final claims]. The system comprises: a processing circuitry; and a memory, the memory containing instructions that, when executed by the processing circuitry, configure the system to: send a response to a first source Internet protocol (IP) address, wherein the response has a modified domain name that includes a first token, the first source IP address, and an original domain name; determine receipt of a return query for the modified domain name, wherein the return query is received from a second source IP address; upon receipt of the return query, determine a second token for the return query by executing a function with respect to the first source IP address in the modified domain name; and validate the return query by comparing the first token and the determined second token, wherein the first token is extracted from the modified domain name of the return query.

Certain embodiments disclosed herein include the method, non-transitory computer readable medium, or system noted above or below, wherein determining receipt of the return query remediates potential malicious attacks from an unvalidated DNS query.

Certain embodiments disclosed herein include the method, non-transitory computer readable medium, or system noted above or below, wherein the return query is valid when the first token is identical to the second token, further including or being configured to perform the following step or steps: adding the first source IP address and the second source IP address of the validated return query to a whitelist.

Certain embodiments disclosed herein include the method, non-transitory computer readable medium, or system noted above or below, further including or being configured to perform the following step or steps: determining a subnet for each of the first source IP address and the second source IP address; and adding IP addresses of the subnet to the whitelist.

Certain embodiments disclosed herein include the method, non-transitory computer readable medium, or system noted above or below, further including or being configured to perform the following step or steps: relaying a subsequent query to at least one name server without the DNS challenge, wherein the subsequent query is received from an IP address in the whitelist.

Certain embodiments disclosed herein include the method, non-transitory computer readable medium, or system noted above or below, further including or being configured to perform the following step or steps: sending a name server address to the second source IP in association to the modified domain name, wherein a third query for the original domain name accesses the DNS name server via the name server address, wherein the third query and the return query is sent from a same source.

Certain embodiments disclosed herein include the method, non-transitory computer readable medium, or system noted above or below, further including or being configured to perform the following step or steps: generating the first token of a first query, wherein the first query from the first source IP address has the original domain name.

Certain embodiments disclosed herein include the method, non-transitory computer readable medium, or system noted above or below, wherein the first token and the second token are each a token, and wherein the token is a random-looking string uniquely generated for each query, wherein the token is generated based on at least one of: a secret, a current time of the each query, the original domain name, and the first source IP address.

Certain embodiments disclosed herein include the method, non-transitory computer readable medium, or system noted above or below, further including or being configured to perform the following step or steps: determining a DNS resolver associated with the first source IP address as a legitimate DNS resolver.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram illustrating the operation of a domain name system (DNS) recursive attack.

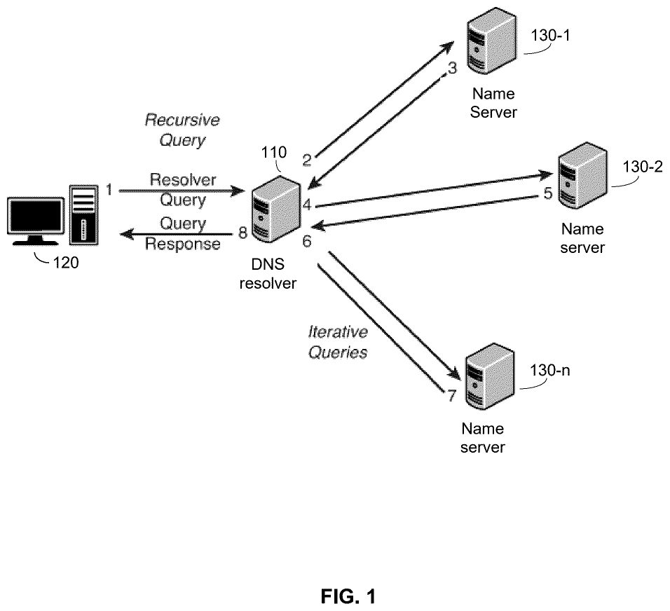

FIG. 2 is a network diagram utilized to describe the various disclosed embodiments.

FIG. 3 is a flowchart illustrating a method defending DNS name servers from DNS attacks according to an embodiment.

FIG. 4 is a flowchart illustrating a method for performing a DNS challenge according to an embodiment.

FIG. 5 is a schematic diagram of a DNS protection system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a system and method for validating an Internet protocol (IP) source of a domain name system (DNS) by employing a DNS challenge. The DNS challenge is performed in response to DNS queries sent from a DNS resolver to at least one name server (e.g., an authoritative name server, or the like) to detect potentially malicious queries from unknown sources such as, but not limited to, attacker sources. The disclosed embodiments provide accurate and efficient determination of legitimate or spoofed IP sources by utilizing a modified domain name. The modified domain name including, for example, but not limited to, a first source IP address, a unique token, and the like, are provided in response to an original DNS query for the original domain name. Upon receiving queries with the modified domain name, a validation using the unique token may be performed to determine the legitimate query and originating IP source.

It has been identified that IP addresses of DNS resolvers are dynamic and may readily change between different DNS queries. Currently implemented techniques do not consider such dynamic changes in IP addresses and each query and its IP address are tested to detect potentially malicious sources. The verification of each individual query is ineffective and adds computational and traffic burden to the system. The drainage is particularly significant in consideration of the amount of DNS queries and responses communicated over the network. In addition, room for error and compromise to malicious sources is greater with extensive processing.

The embodiments disclosed herein utilize the modified domain name that incorporates at least the IP address of the original query in order to validate subsequent queries with respect to the original query and IP source. To this end, legitimate queries and IP sources are determined independently from the IP address of the subsequent queries to improve accuracy and efficiency in validating the queries.

Moreover, embodiments disclosed herein utilize a subnetwork (subnet) of IP addresses to identify a group of IP addresses that are associated with the identified legitimate IP sources. The IP addresses within the subnet are identified simultaneously based on the source IP detected while performing the DNS challenge. It should be noted that utilizing the subnet of IP addresses allows efficient determination of legitimate IP sources to conserve computational resources. In an embodiment, the IP addresses of the validated queries and the subnet of IP address associated with the validated queries are added to a whitelist of safe and legitimate IP addresses. The whitelist is checked for subsequent queries to relay queries originating from the whitelisted IP addresses directly to the name server without further processing and validation.

The modified domain name of the disclosed embodiments includes a unique token that is generated with respect to a first source IP address that queries the original domain name. The first IP address and the first token is carried by the modified domain name and may be readily extracted therefrom. It should be appreciated that the modified domain name disclosed herein allows rapid validation of the subsequent queries by extracting the first token the first IP address without repeated determination of the first token. To this end, validation is performed with improved accuracy and efficiency.

The embodiments disclosed herein protect the name servers from potential DNS attacks from spoofed DNS sources (e.g., a spoofed DNS resolver). The DNS challenge response to the queried IP address with the modified domain name for validation prior to allowing access through the communications network and to the name server. A failed return of the query with the modified domain name suggests a spoofing of the source that sent the query. Here, the spoofed source fails to receive the response of the modified domain name, and thus fails to echo back the query with the modified domain name. In such a scenario, the spoofed source that impersonates a legitimate source is blocked in the traffic, thereby remediating potential DNS-based cyber threats. It should be further noted that the disclosed embodiments of validating, blocking, and relaying DNS queries are performed by reading inbound traffic in the DNS infrastructure and may be readily implemented without adding complexity and disrupting the infrastructure and other protection systems.

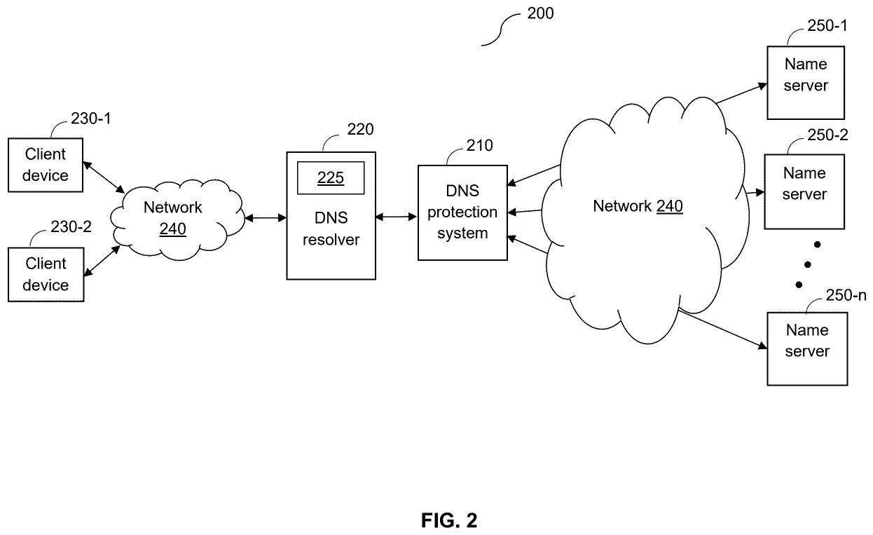

FIG. 2 shows an example network diagram 200 utilized to describe the various disclosed embodiments. In the example network diagram 200, a domain name system (DNS) protection system 210 is deployed between a DNS resolver 220 and a plurality of authoritative DNS name servers 250-1 through 250-n (herein referred to individually as a “name server” 250 and collective as “name servers” 250, merely for simplicity purposes) that are connected via, for example, a network 240. The DNS resolver 220 is further communicatively connected to one or more client devices 230-1 and 230-2 (collectively referred to client devices 230, merely for simplicity purposes) via, for example, a network 240. The network 240 may be, but is not limited to, a local area network (LAN), a wide area network (WAN), the Internet, similar networks, and any combination thereof.

The client devices 230 may be devices providing DNS queries to resolve domain names (e.g., www.example.com). The client devices 230 are configured to send DNS queries to the DNS resolver 220 and to receive, in return, IP addresses of the corresponding queried domain names for access via a browser at the client device 230.

The DNS resolver 220 is a server, a component, or the like, configured to return an IP address corresponding to a domain name in response to a DNS query (request) received from one of the client devices 230. The DNS resolver 220 may be configured with a cache 225 to store IP address of domain names that are resolved through communication with the name servers 250. It should be noted that a single DNS resolver 220 is shown for simplicity and does not limit the scope of the disclosed embodiments. One or more DNS resolvers 220 may be connected to the name server 250 to query and retrieve information such as, but not limited to, an IP address from one of the name servers 250, and the like, on the queried domain names.

According to the disclosed embodiments, the DNS resolver 220 may be a legitimate resolver or a spoofed resolver. The spoofed resolver may be a malicious server, component, device, or the like that masquerades as a legitimate resolver to send queries including fake or spoofed IP addresses to the name servers 250. An attacker may employ the spoofed resolver to gain access and execute DNS attacks on the name servers 250. In such a scenario, the trusted resolver or sources may be masked from the name servers 250. Some example DNS attacks may include, and without limitation, a DDoS attack, a DNS amplification, a reconfiguration, installation of malware, a DNS tunnel creation, and the like, and more. In an example embodiment, the spoofed resolver may not be connected to the client devices 230 to receive domain name requests, and instead, the malicious queries may be created at the spoofed resolver for the DNS attacks. It should be noted that the spoofed malicious resolvers may be difficult to identify, and thus, a defense mechanism is executed to confirm validity of queries and the source DNS resolver 220.

In an example DDoS attack, a spoofed resolver 220 may send a large number of queries to a name server 250 in a short amount of time to overload the name server. The spoofed resolver 220 utilizes a different spoofed source IP address for each query to impersonate different resolvers sending legitimate queries. In such a scenario, the name server may fail to distinguish spoofed and legitimate queries and be overloaded to process all received queries. Consequently, such overload of spoofed queries disrupts or paralyzes the traffic and victim name server for normal operations.

The name servers 250 are DNS servers that store information about domain names and corresponding IP addresses, which are provided as answers to queries of domain names from the DNS resolver 220. The name servers 250 are configured to answer only the queries for the zones (e.g., an IP address range) that it is responsible for quickly responding to the resolver queries. The name server 250 does not respond to recursive queries and does not cache query results.

In an example embodiment, in order to resolve a full qualified domain (FQDN), the DNS resolver 220 checks if an IP address for the domain name is saved in the cache 225 of the DNS resolver 220. If so, the IP address is returned in a query response. If the query cannot be resolved based on the cached information, the DNS resolver 220 queries a root name server (e.g., the name server 250-1). If the root name server 250-1 is authoritative for the top-level domain, it returns an IP address of a name server (e.g., the name server 250-2) that is capable of resolving the subdomain. However, if the root name server 250-1 is not authoritative for that top-level domain name, a recursive process begins by querying the name servers 250 until the domain name is fully resolved. A fully resolved domain name is cached at the DNS resolver 220 and returned as a query response to the client device 230 that sent the DNS query.

The DNS protection system 210 is a server, a system, a component, or the like that is configured to validate queries that are sent from an IP source (e.g., the DNS resolver 220) to the name servers 250. A defense against DNS attacks such as, but not limited to, a DDoS attack, a DNS amplification, a reconfiguration, and the like, at the name servers 250, is performed through blocking of spoofed IP sources (e.g., a spoofed DNS resolver 220) by performing a DNS challenge and validating the IP sources. The DNS challenge utilizes a name server (NS) response (or a delegation response) that responds to queries using an address of the designated authoritative name server (e.g., the name server 250-1). A standard DNS resolver 220 may generate a second query based on the NS response. In an embodiment, queries sent from an unknown DNS resolver 220 are validated by performing a DNS challenge using a modified domain name. Each query includes an original domain name in order to resolve the FQDN and retrieve its corresponding IP address. In an example embodiment, a DNS resolver 220 is identified as an unknown source upon determination that the IP address of the respective DNS resolver 220 is missing in a whitelist. In a further example embodiment, the whitelist may be stored in a memory and/or a database (not shown) of the DNS protection system 210.

The DNS protection system 210 is configured to perform the DNS challenge by responding to the queries using the modified domain name. The modified domain name is generated to include, for example, but not limited to, a first source IP address (hereinafter referred to as “a first IP” for simplicity), a unique token, the original domain name, and the like. The modified domain name of the response may indicate an authoritative name server (e.g., the name server 250-1) that holds the IP address corresponding to the original domain name. Here, the first IP is an IP address of, for example, the unknown IP source (e.g., the unknown DNS resolver 220) from which the first query of the original domain is received. In an embodiment, the unique token is generated by executing a hash function based on parameters such as, but not limited to, a secret, a current time of query, a domain name, the first IP, and the like, and any combination thereof. The token may be a random string that is uniquely generated for the query based on the parameters.

In an embodiment, the DNS challenge response including the modified domain name is sent to the first IP. An echo (i.e., a returned query) of the modified domain name of the DNS challenge is used as an indicator for the legitimate or spoofed resolver 220. It should be noted that the DNS challenge response may not reach the malicious servers of the spoofed resolver 220 due to the fake IP addresses and thus, the echo of the modified domain name may not occur. To this end, the query from the malicious server is blocked from reaching the name server, thereby remediating potential DNS attacks from the spoofed resolver 220. It should be noted that the remediation of DNS attack is naturally implemented by performing the DNS challenge to confirm the legitimate resolver 220 and/or eliminating further communication with the spoofed resolver 220.

As an example, the DNS protection system 210 may receive a query for an original domain name ‘www.example.com’ from an unknown IP source with an IP address of ‘K’ (i.e., the first IP is ‘K’). The DNS protection system 210 performs a DNS challenge against the unknown DNS resolver 220 that is, for example, absent in the whitelist. A unique token is generated for the query by executing a hash function, f(x), as follows, based on parameters of a secret, time of query, original domain name, and the first IP:
token=f(secret, current time, ‘www.example.com’, K)

In the same example, a modified domain name, indicating the authoritative name server of the original domain name, may be generated as below. The protection system 210 is configured to send a response including the modified domain name, shown below, to the IP address ‘K’ of the received query. The generated unique token is added to the modified domain names and is not separately stored or tracked at the DNS protection system 210.
token-K.www.example.com

The DNS protection system 210 is further configured to validate subsequent queries that include the modified domain names. The hash function is executed for each of the subsequent queries received from a second source IP address (hereinafter referred to as the second IP), using the information included in the modified domain name, to determine a second token for each of the subsequent queries. That is, the hash function is executed using the domain name and the first IP (e.g., ‘K’).

Following the example from above, the subsequent queries may include the modified domain name “first_token-K.www.example.com” and thus, the second token is determined by executing the hash function, f (secret, second current time, ‘www.example.com’, K). The secret is unchanged across different queries and the first IP ‘K’ indicated in the modified domain name is utilized in the hash function. In an embodiment, the second token may be compared to the first token (i.e., “first_token”) as indicated in the modified domain name “first_token-K.www.example.com,” thereby validating the second IP of the second token. In an example embodiment, a low resolution current time parameter, for example, of 1-2 minutes, may be implemented to allow sufficient validation of second queries received from the legitimate DNS resolver 220. The modified domain name may be parsed to extract, for example, but not limited to, the first token, the first IP, the domain name, and the like, and any combination thereof. In an embodiment, the source IP address (e.g., the second IP) of the validated subsequent query may be added to the whitelist. The first IP and the second IP may be identical or different. When the second IP and the first IP is identical, the exact IP address of all 32 bits of the first IP address is added to the whitelist. As an example, the first IP, ‘K,’ is denoted as K/32 and the full address is whitelisted.

In some embodiments, a single DNS resolver 220 may send queries using different

IP addresses, for example, within a subnet. That is, the IP address of the original query and that of the subsequent queries may differ even for the single resolver 220. It should be noted that hash function, for example, f(secret, current time, ‘www.example.com, ‘a first IP’), is executed with respect to the domain name and the first IP that is commonly extracted from the original query and the subsequent queries, regardless of the IP address sending the query. To this end, the validation may be accurately determined for the originating DNS resolver 220 and independent from the source IP address for each query.

In a further embodiment, IP addresses in the subnet of the validated first IP and/or second IP may be identified and added to the whitelist. Non-equal IP addresses of the first IP ‘K’ and the validated second IP ‘B’ suggest that the IP address of the resolver may have changed. In an example embodiment, upon validation of the second token received from a second IP, ‘B’, that is not equal to the first IP ‘K’, the second IP as well as IP address within the subnet are added to the whitelist by utilizing, for example, but not limited to, the B/24 subnet mask, the B/23 subnet mask, the B/25 subnet mask, or the like. In addition, the IP addresses of the K/24 subnet mask are added to the whitelist. The subsequent queries for an original domain name received from the subnet of verified source IP ‘B’ may be determined as valid and legitimate DNS resolvers 220 and thus, bypass the DNS challenge. It should be noted that identification and whitelisting of subnets eliminates repeated performance of the DNS challenge for each unknown IP source of the queries, thereby reducing computational power and time. It should be noted that the DNS challenge not only eliminates potentially malicious spoofed DNS resolvers, but also accurately and efficiently identifies legitimate DNS resolvers 220 that request access to the name server 250 to resolve the FQDNs.

According to the disclosed embodiments, the DNS protection system 210 is configured to monitor DNS traffic between the DNS resolver 220 and the name servers 250 to parse and validate DNS queries of the DNS traffic. The DNS challenge is performed through communication with the DNS resolver 220 prior to relaying a query to the name servers 250. In an embodiment, the DNS protection system 210 is configured to relay the query of the original domain name to the authoritative name server (e.g., the name server 250-1). It should be noted that the DNS protection system 210 does not communicate with name server 250. Rather, the DNS protection system 210 is configured as a checkpoint that validates, eliminates, and/or performs challenges against DNS queries before any packets are given access to the name servers 250. In an embodiment, legitimate sources are identified and whitelisted to provide direct communication between the DNS resolver 220 and the name server 250. The direct communication eliminates interruption and points of potential attacks on the DNS traffic to ensure a layer of security to protect the system, servers, and the like. It should be further noted that the DNS protection system 210 processes inbound traffic directed to the name servers without disrupting the routine DNS traffic. To this end, the DNS protection system 210 disclosed herein may be readily deployed as part of a larger DDoS protection system that remediates potentially malicious attacks without additional traffic packets or like complications within the communication.

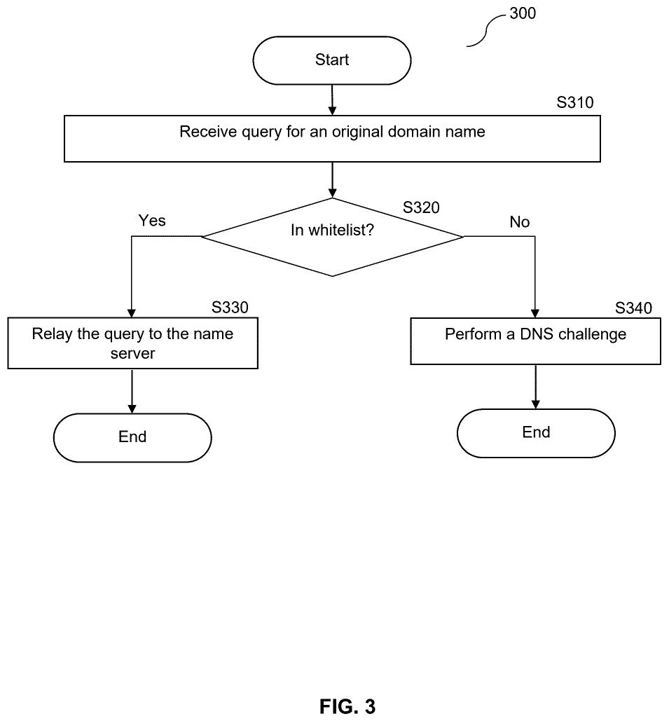

FIG. 3 is an example flowchart 300 illustrating a method for defending a DNS name server from DNS attacks via a DNS challenge according to an embodiment. The method described herein is performed in the DNS protection system 210, FIG. 2.

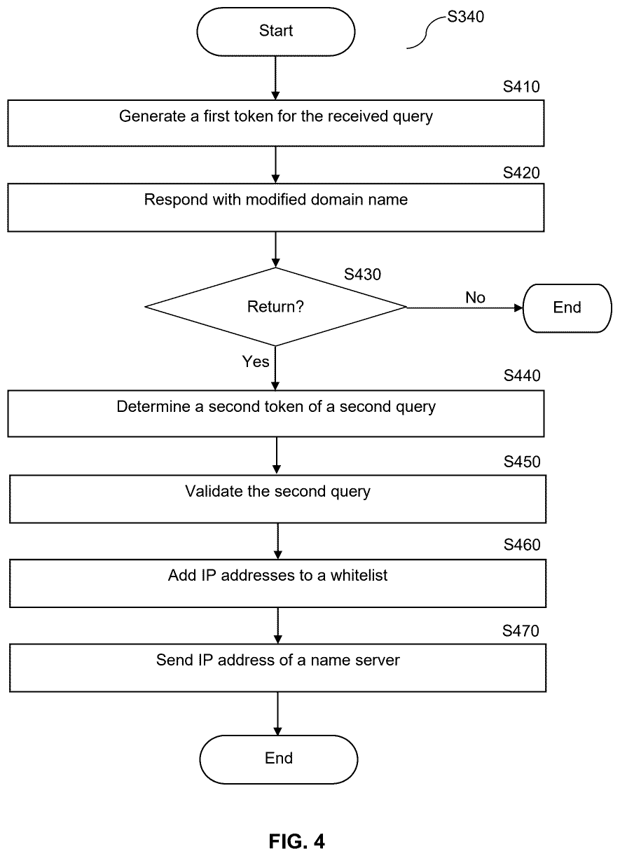

At S310, a query for an original domain name is received. The query may be received from a DNS resolver (e.g., the DNS resolver 220, FIG. 2) to retrieve an IP address of the original domain name. The original domain name is an unmodified domain name for a website and/or webpage. At least the original domain name of the request and a first IP address (or simply a first IP) of the DNS resolver that sent the query is extracted from parsing the query. The query may be received by monitoring traffic between the DNS resolver and one or more DNS name servers (e.g., the name servers 250, FIG. 2). In an embodiment, when the received query includes a modified domain name including a token, the operation may continue with S430, FIG. 4 of the DNS challenge to determine whether the DNS resolver of the received query is a legitimate or a spoofed DNS resolver. The original domain is the domain that is not modified. As an example, the original domain name may be ‘www.example.com’.

At S320, it is checked if the requesting first IP is in a whitelist. If so, execution continues with S330 to forward the query including the original domain name to the name server. Otherwise, the operation continues with S340 to perform a DNS challenge.

At S330, the query including a whitelisted IP address is relayed to the name server. The whitelist includes IP addresses of sources (or DNS resolvers) that are determined to be legitimate and may include subnet of IP addresses that are associated with the IP address of legitimate DNS resolvers. In an example embodiment, the whitelist may be stored in a memory and/or a database of the DNS protection system (e.g., the DNS protection system 210, FIG. 2). In an embodiment, the query received from the whitelisted IP address is relayed without modification or new creation of DNS packets. It should be noted that the relaying of the query allows effective DNS query validation and deployment in a large DDoS protection system. Such validation methods may be performed without adding complexity to the DNS infrastructure and protection system.

At S340, the DNS challenge is performed to validate the source IP (or DNS resolver) from which the query is received. The DNS challenge is executed as a defense technique to protect potentially malicious queries from spoofed DNS resolvers from accessing the name servers. Moreover, the DNS challenge identifies legitimate DNS resolvers and their IP addresses to be whitelisted for subsequent queries. The detailed method of performing the challenge is described further herein below in FIG. 4.

It should be noted that the malicious queries are tested during the DNS challenge and blocked from reaching the name server of the queried domain name. The malicious queries are eliminated during the process thereby remediating the name servers from potentially malicious DNS attacks such as, but not limited to DDoS attacks. In an embodiment, the method described in FIG. 3 is performed for all queries detected in the inbound traffic from the resolver to the name server, including a query received from a legitimate resolver freshly identified using the DNS challenge of FIG. 4.

FIG. 4 is an example flowchart S340 illustrating a method for performing a DNS challenge to identify a legitimate IP source according to an embodiment. The method is performed by a DNS protection system 210, FIG. 2 that is employed between a DNS resolver 220, FIG. 2, and one or more name servers 250, FIG. 2. In an embodiment, the DNS challenge may be performed upon receiving a query from an unknown source or DNS resolver that is absent from the whitelist of IP addresses.

The disclosed embodiments provide a method for rejecting spoofed IP sources (e.g., DNS resolver 220, FIG. 2) and/or detecting legitimate IP sources. In addition, the IP addresses of legitimate sources are verified and identified with improved efficiency and accuracy. The method of FIG. 4 is described with respect to the DNS resolver 220 as the IP source for illustrative purposes. However, it should be noted that the IP source from which the query is received may be a server, a component, a system, or the like, without departing the scope of the disclosed embodiments.

At S410, a first token is generated for the received query for the original domain. The query for the original domain received from a first source IP address (hereinafter referred to as “a first IP” for simplicity) is the first query. The first token is generated using a hash function that is executed based on parameters such as, but not limited to a secret, a current time of query, a domain name, a first IP, and the like, and any combination thereof. The domain name is the original domain of the query, and the first IP is the IP address from which the first query including the original domain is received. In an embodiment, the token is a random string that is uniquely generated for each query based on the parameters. For example, a first query for an original domain, ‘www.example.com’, is received from an unknown DNS resolver with a first IP address (i.e., first IP) of ‘K’. The first token may be generated by executing a following hash function, f(x):
first token=f(secret, current time of the first query, ‘www.example.com’, ‘K’).

At S420, a response including a modified domain name is sent to the first IP of the unknown DNS resolver. The response is sent as a reply to the first query in order to direct the query to an authoritative name server that stores, for example, but not limited to, A records, IP addresses, of the original domain, and the like, and more. In an embodiment, the modified domain name includes at least the generated first token and the first IP. As an example, the modified domain name may be ‘first_token-K.www.example.com’ to incorporate the generated first token, ‘first_token’, the first IP, ‘K’, and the original domain ‘www.example.com’.

At S430, it is checked if a query for the modified domain name is returned by monitoring the DNS traffic. If so, operation continues with S440, otherwise, the operation terminates.

The subsequent queries that are received are parsed to identify a return of the identical modified domain name that was sent in S420. Such subsequent query including the modified domain name is a second query of the original domain. The second query may be received via a second source IP address (hereinafter simply referred to as the second IP). It should be noted that a single DNS resolver may change its IP address when communicating via DNS. Thus, the first IP and the second IP of the source DNS resolver may be the same or different.

In an embodiment, the unreturned query for the modified domain name indicates that the respective DNS resolver has not passed the DNS challenge. The name servers are protected against the respective DNS resolver that did not return the query for the modified domain name. In the process, potential malicious DNS attacks on the name servers are remediated by preventing traffic and access of the unknown respective DNS resolver to the name servers. In an example embodiment, the second query may not be received in return when the response including the modified domain name is sent to a spoofed DNS resolver based on the first query. The spoofed DNS resolver is disguised as a trusted source and includes a fake IP address (or fake first IP) in the first query. The fake IP may be a fictitious address that is not associated with DNS resolver to return the second query.

In an embodiment, the second query (or return query) may be returned (or echoed) when the response including the modified domain name is sent to a legitimate DNS resolver associated with the first IP. In an example embodiment, the modified domain name may be identified by the token at the beginning of the modified domain name. In an embodiment, a token is uniquely generated for the query and may act as an identifier to authenticate the returned second query.

At S440, a second token for the second query is determined. The second token is determined based on execution of the hash function on the second query parameters. The second query parameters for the hash function may include, for example, but not limited to, a secret, a second query current time, the domain name, the first IP, and the like. It should be noted that the modified domain name generated as disclosed herein provides the first IP and the first token that may otherwise be unavailable. In an example embodiment, the second token is calculated using the hash function, f(x), as with the first token according to the following:
second token=f(secret, current time of the second query, ‘www.example.com’, ‘K’).

The token for the query are determined using the same secret, the original domain name, and the first IP, ‘K’, as provided in the modified domain name. In an embodiment, a low resolution of current time is used which results in the first token and the second token that are similar, if not identical. As an example, the current time resolution is about 1-2 minutes so that the current time of the first query and the current time of the second query is the same.

At S450, the second query is validated as a legitimate query. The first token of the first query is compared to the second token of the second query. In an embodiment, the second query is validated as the legitimate query upon determination that the second token is identical to the first token. The first token may be extracted from the modified domain name of the second query that carries the first token, first IP, and the original domain name. For example, the value ‘first_token’ is retrieved from the modified domain name: “first_token-K.www.example.com”. It should be noted that the validated second query indicates that the communicating DNS resolver is a legitimate server. In an embodiment, the second query is determined to be invalid based on a difference between the second token and a first token that is beyond the predefined range, for example, non-identical tokens. The operation stops upon the determination that the second query is invalid. It should be noted that the first token is carried in the modified domain name for facilitated extraction. To this end, storing or tracking of the first token is not performed to prevent overload and conserve computational resources and memory at the DNS protection system (e.g., the DNS protection system 210, FIG. 2).

At S460, IP addresses are added to a whitelist. The first IP and the second IP from the validated queries are added to the whitelist. The first IP and the second IP may be the same or different. In an embodiment, the exact IP addresses /32 of the first IP and/or the second IP is added to the white. In an embodiment, the DNS resolver may utilize one or more IP addresses of a subnet to query for the domain name. Thus, the subnet of IP addresses associated with the first IP and/or the second IP are identified and added to the whitelist. The subnet is a group of IP addresses that are within a smaller network that may be grouped or closely located. In an example embodiment, the IP addresses within the /24 subnet of the first IP and/or the second IP may be added to the whitelist. The IP addresses in the /24 subnet use 24 bits of the 32 bits of the address. Different subnet masks, for example, but not limited to, /24 subnet mask, /23 subnet mask, or the like, and any combination thereof may be used to determine a subnet and IP addresses within the subnet. The plurality of legitimate IP addresses may be simultaneously added to the whitelist by incorporating subnet of IP addresses, thereby increasing computational efficiency. In an embodiment, the whitelisted IP address may be utilized to identify legitimate queries and DNS resolvers that are sent from varied IP addresses of the subnet. It should be further noted that identifying and whitelisting IP address of the subnet eliminates repeated process of performing the DNS challenges and validating individual IP addresses.

At S470, a name server IP address is sent to the second IP in response to the validated second query. The name server IP address (hereinafter referred to as an NS IP) is the IP address of the authoritative name server that stores information to resolve the original domain of the first query. Following the example above, the authoritative NS holds information to resolve the original domain of the first query, ‘www.example.com’. In an embodiment, the legitimate DNS resolver may use the received NS IP as the destination IP for a third query for the original domain name. The third query from the DNS resolver directly queries the received NS IP.

According to the disclosed embodiments, legitimate queries (i.e., from legitimate DNS of whitelisted IP addresses) of the original domain may be relayed to one or more name servers (e.g., the name servers 250, FIG. 2) as described in FIG. 3 to determine the FQDN. The response from the name servers is sent directly to the legitimate DNS resolver. It should be noted that the DNS protection system (e.g., the DNS protection system 210, FIG. 2) is configured as a defense and validation mechanism to prevent malicious access to the name servers and to discover legitimate source IPs. To this end, the DNS protection system does not interfere with or modify DNS communications between name servers and legitimate sources.

In an embodiment, the DNS protection system is configured to communicate with legitimate and/or spoofed resolvers during the DNS challenge, and thus, access to the name servers may be prevented prior to validation of IP sources. Moreover, the DNS protection system does not create and send DNS packets to the name servers. To this end, the embodiments disclosed herein remediate potential points of attack from, for example, a comprised DNS protection system, thereby improving protection from cyber-attacks.

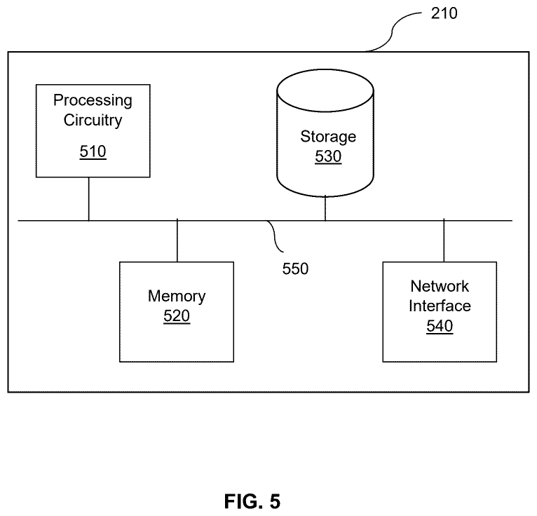

FIG. 5 is an example schematic diagram of a DNS protection system 210 according to an embodiment. The DNS protection system 210 includes a processing circuitry 510 coupled to a memory 520, a storage 530, and a network interface 540. In an embodiment, the components of the DNS protection system 210 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 540 allows the DNS protection system 210 to communicate with other systems, devices, components, applications, or other hardware or software components, for example as described herein.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for defending a domain name system (DNS) name server from malicious attacks using a DNS challenge, comprising:
sending a response to a first source Internet protocol (IP) address, wherein the response has a modified domain name that includes a first token, the first source IP address, and an original domain name;
determining receipt of a return query for the modified domain name, wherein the return query is received from a second source IP address;
upon receipt of the return query, determining a second token for the return query by executing a function with respect to the first source IP address in the modified domain name; and
validating the return query by comparing the first token and the determined second token, wherein the first token is extracted from the modified domain name of the return query.

2. The method of claim 1, wherein determining receipt of the return query remediates potential malicious attacks from an unvalidated DNS query.

3. The method of claim 1, wherein the return query is valid when the first token is identical to the second token, further comprising:
adding the first source IP address and the second source IP address of the validated return query to a whitelist.

4. The method of claim 3, further comprising:
determining a subnet for each of the first source IP address and the second source IP address; and
adding IP addresses of the subnet to the whitelist.

5. The method of claim 4, further comprising:
relaying a subsequent query to at least one name server without the DNS challenge, wherein the subsequent query is received from an IP address in the whitelist.

6. The method of claim 1, further comprising:
sending a name server address to the second source IP in association to the modified domain name, wherein a third query for the original domain name accesses the DNS name server via the name server address, wherein the third query and the return query is sent from a same source.

7. The method of claim 1, further comprising:
generating the first token of a first query, wherein the first query from the first source IP address has the original domain name.

8. The method of claim 1, wherein the first token and the second token are each a token, and wherein the token is a random-looking string uniquely generated for each query, wherein the token is generated based on at least one of: a secret, a current time of the each query, the original domain name, and the first source IP address.

9. The method of claim 1, further comprising:
determining a DNS resolver associated with the first source IP address as a legitimate DNS resolver.

10. A non-transitory computer readable medium having stored thereon instructions for causing a processing circuitry to execute a process, the process comprising:
sending a response to a first source Internet protocol (IP) address, wherein the response has a modified domain name that includes a first token, the first source IP address, and an original domain name;
determining receipt of a return query for the modified domain name, wherein the return query is received from a second source IP address;
upon receipt of the return query, determining a second token for the return query by executing a function with respect to the first source IP address in the modified domain name; and
validating the return query by comparing the first token and the determined second token, wherein the first token is extracted from the modified domain name of the return query.

11. A system for defending a domain name system (DNS) name server from malicious attacks using a DNS challenge, comprising:
a processing circuitry; and
a memory, the memory containing instructions that, when executed by the processing circuitry, configure the system to:
send a response to a first source Internet protocol (IP) address, wherein the response has a modified domain name that includes a first token, the first source IP address, and an original domain name;
determine receipt of a return query for the modified domain name, wherein the return query is received from a second source IP address;
upon receipt of the return query, determine a second token for the return query by executing a function with respect to the first source IP address in the modified domain name; and
validate the return query by comparing the first token and the determined second token, wherein the first token is extracted from the modified domain name of the return query.

12. The system of claim 11, wherein determining receipt of the return query remediates potential malicious attacks from an unvalidated DNS query.

13. The system of claim 11, wherein the return query is valid when the first token is identical to the second token, wherein the system is further configured to:
add the first source IP address and the second source IP address of the validated return query to a whitelist.

14. The system of claim 13, wherein the system is further configured to:
determine a subnet for each of the first source IP address and the second source IP address; and
add IP addresses of the subnet to the whitelist.

15. The system of claim 14, wherein the system is further configured to:
relay a subsequent query to at least one name server without the DNS challenge, wherein the subsequent query is received from an IP address in the whitelist.

16. The system of claim 11, wherein the system is further configured to:
send a name server address to the second source IP in association to the modified domain name, wherein a third query for the original domain name accesses the DNS name server via the name server address, wherein the third query and the return query is sent from a same source.

17. The system of claim 11, wherein the system is further configured to: generate the first token of a first query, wherein the first query from the first source IP address has the original domain name.

18. The system of claim 11, wherein the first token and the second token are each a token, and wherein the token is a random-looking string uniquely generated for each query, wherein the token is generated based on at least one of: a secret, a current time of the each query, the original domain name, and the first source IP address.

19. The system of claim 11, wherein the system is further configured to:
determine a DNS resolver associated with the first source IP address as a legitimate DNS resolver.
